(19) United States
(12) Patent Application Publication
(10) Pub. No.: US 2008/0086337 A1
(43) Pub. Date: Apr. 10, 2008

(54) Web based integrated information system for sharing patient medical information cross-organizationally

(76) Inventor: Patrick Soon-Shiong, Los Angeles, CA (US)

Correspondence Address: MORRISON & FOERSTER LLP, 755 PAGE MILL RD, PALO ALTO, CA, 94304-1018, US

(21) Appl. No.: 11/891,291

(22) Filed: Aug. 8, 2007

Related U.S. Application Data
(60) Provisional application No. 60/837,225, filed on Aug. 10, 2006.
(60) Provisional application No. 60/840,292, filed on Aug. 25, 2006.

(51) Int. Cl. G06Q 50/00; G06Q 10/00

(52) U.S. Cl. 705/3

(57) ABSTRACT

Web-based system and computer enabled method for storage and distribution of medical information pertaining to patient care. This allows various actors in the medical care field to exchange information pertaining to particular patients in the form of electronic medical records.

### CROSS-REFERENCE TO RELATED APPLICATIONS

This application claims priority to U.S. provisional application 60/837,225 filed Aug. 10, 2006; and U.S. provisional application 60/840,292 filed Aug. 25, 2006, both incorporated by reference in their entireties.

### FIELD OF THE INVENTION

This invention relates to health care information systems.

### BACKGROUND

The last decade has seen an explosion of scientific insight into the molecular pathways affecting normal and diseased cells, rapidly translating into molecularly targeted therapeutic options for patients. The era of customized medicine and target-specific therapy has arrived. Increasingly therapeutic choices will be made based on the patient's specific gene profile, the tumor specific over-expression of receptors and the stage of the life-cycle of the disease. With this rapid evolution of both fundamental biology and the rapid translation of this knowledge into clinical medicine there is an increasing need for all stakeholders in the management of health care to access real time and objective information upon which to base therapeutic decisions in an evidence-based fashion. With the advent of these next generation technologies both as approved drugs (Herceptin, Avastin, Tykarb, Tarceva, Irressa, Erbitux, Gleevec etc) and drugs in clinical development, the need for the practicing physician and the patient to access and implement up to date clinical information are now paradoxically greater than when the therapeutic choices were fewer.

These issues are present in many areas of health care. While the examples in this application describe life-threatening diseases such as cancer, the same applications are intended for all life-threatening diseases afflicting patients such as cardiac disease, neurodegenerative disease, diabetes, infections, transplantation, inflammatory disease, etc. The complexity is highlighted in, for example, the war against cancer. For the past 50 years the armamentarium available to oncologists and cancer patients has been cytotoxic medicines that act in some fashion to poison the cell to stop division and hormonal therapies which deprive cancer cells of steroidal growth factors. In the last decade an exponential gain has occurred in the knowledge of specific receptors which are over-expressed in tumor cells. Discovery efforts have led to the elucidation of a multitude of receptor types (Her2, MEK, mTOR, FT, SPARC etc) and a network of messenger molecules at the intra-cellular level. These and others provide potential targets for next generation therapeutics and currently over 300 molecules are under development. The receptors and pathways involved in cancer and its progression are complex. There are multiple intersecting receptors and pathways, many of which undergo cross-talk and interactivity. Of clinical relevance, one or more of the receptors and the response in any one patient may differ from those of another patient with the same cancer type. Thus, there are responders and non-responders in patients with the same cancer type with differing molecular profiles. Such complexity suggests a need for specific treatments and carefully evaluated treatment choices. What is efficacious in one patient may have a greater, lesser, or absence of an effect in another. The knowledge and efficacy specificity is evolving dramatically and represents a huge challenge to the practicing clinician to keep abreast of the optimal cocktails of drugs under varying molecular conditions, and clearly almost impossible for the lay patient to maintain state of the art knowledge in the highly technical field of molecular medicine. An integrated active information system, including but not limited to a seamless, real time system, based on objective state of the art evidence, customized to the specific and event-driven episodes of the disease as it progresses, is sorely needed. Such a system would have substantial positive implications in both the practice and cost of medicine.

The complexities involved in the day to day operational activities affecting drug innovation, drug manufacture, clinical trial management, drug reimbursement and drug distribution, combined with the specific and personalized dynamic affecting doctor-patient relationships in situations whereby the patients face life-threatening crises, are enormous. The complexity of these interrelations and interactions, as well as the absence of working knowledge of all aspects of the above supply chain of a medicament (from discovery to administration to a patient) have prevented the creation of a seamless, fully integrated, real-time interconnectivity which would allow for the implementation of clinical decisions to provide best practices in patient care, with the most cost-effective method of providing such care, with the same quality standards provided whether treatment is provided in an academic tertiary center or whether from a rural remote setting, with the opportunity to avoid medication errors.

There are multiple unmet needs facing each element of the health care supply chain, including clinical information needs, drug development clinical trial needs, supply needs and cost-containment needs, which would benefit from being addressed in a comprehensive system. Nonlimiting examples of such needs include:

With the rapid expansion of targeted and customized drug development, there is a need for the innovator to access patient populations with appropriate phenotypes for clinical trial accruals.

With the rapid expansion of both preclinical and clinical knowledge of multiple new clinical protocols, there is the need for the practicing clinician and payor to maintain state of the art awareness of best practices and evidence-based pathways.

With the rapidity and breadth of clinical trial development, there is the need for patients to be aware of newly approved drugs or clinical protocols addressing their specific disease and perhaps their specific tumor receptor type.

With the ability to intervene early and prevent life-threatening conditions such as infection, thereby preventing hospitalization, there is a need for both patient and physician to access timely alert systems allowing preventative intervention and hence cost-savings.

With complexities of next generation drug manufacture involving the production of, for example, complex protein molecules, nanoparticles and monoclonal antibodies, there is a need for real time understanding of demand to accommodate the long lead times necessary to ensure adequate supply both at the clinical trial stage and approved stage of the drugs life-cycle.

With standards of care differing from location to location and physician to physician there is a need to standardize care based on evidence-based protocols.

With the large number of medication errors resulting in serious adverse events and death, there is a need to reduce such errors via electronic checks and use of bar coding.

With the poor compliance in patients regarding following prescribed medications, there is a need to monitor and alert patients and physicians when this occurs.

### SUMMARY

To date, no system exists which adequately integrates the needs of a diverse community of entities with interests linked by the treatment of a patient, for example, the care-giver, the physician, the innovator, the clinical trial manager, the payor, the manufacturer and the supplier. The present method and system is directed to this. In some embodiments in accordance with the present invention, an integrated system links any one or more of the care-giver, the physician, the innovator, the clinical trial manager, the payor, the manufacturer and the supplier. In some embodiments an integrated system links all of the care-giver, the physician, the innovator, the clinical trial manager, the payor, the manufacturer and the supplier. Such an integrated information system, including but not limited to one which provides connectivity via the web in real-time, would revolutionize the practice of health care and create tremendous advances in the supply chain. Such advances include but are not limited to:
accelerating clinical development of next generation therapeutics,
promoting evidence-based best practices,
providing transparency and access of information to patients in real-time including medical information relevant to their daily care,
providing efficiency and real-time support tools, for example, alerts to one or more of care-givers or patients, allowing rapid and timely preventative or therapeutic intervention in the entire life-cycle of that patient's disease,
allowing transparency to the payor in the patients day to day care and both provider and patient's needs with ultimate cost savings in best practices and preventative care,
allowing for cost savings through the efficiency, preventative and supply aspects of health care management throughout the life-cycle of the disease,
allowing standardized quality standards of care,
minimizing medication errors, and
ensuring compliance with prescribed medications and completing dosage.

In some embodiments an integrated system in accordance with the invention provides any one or more of the benefits described herein. In some embodiments an integrated system provides any one or more of the benefits described hereinabove. In some embodiments an integrated system described herein provides all of these benefits. In some embodiments an integrated system described herein provides all of the benefits described herein. In some embodiments an integrated system described herein provides all of the benefits described hereinabove.

Contemplated is a computer enabled method for exchange of patient related medical data, comprising the acts of: providing a patient record having data pertaining to a patient, the record being held by a first health care organization; communicating over a computer network at least a portion of the record to a second health care organization, thereby establishing a shared patient record; and allowing access to the shared patient record over the computer network by a third health care organization. Further, the computer network is, e.g., the Internet and the access is via a conventional web browser.

Further, each of the organizations is one, e.g., of a physician's office, hospital, pharmacy, and insurer, payor for medical care, drug manufacturer, drug distributor, drug developer, clinical trial manager, laboratory, or test facility. Further, the data includes at least one of the patient's genotype, gene-over-expression, or specific drug response. Further, the method includes: establishing a database relating to a clinical trial of a drug, medical device, or procedure; and storing at least a part of the shared patient record in the database. Further, the method includes accessing the database to show a particular patient's medical status and clinical trial status.

The method further includes: providing a distribution function; and accessing the shared patient record by the distribution function; wherein the distribution function determines distribution of drugs, medical devices, or medical supplies to the patient. Further, the distribution function performs activities selected from the group consisting of calculating drug doses, managing local drug inventories, and managing central location drug inventories. The method further comprises providing a database of general clinical data; associating data from a patient record with the database; and providing the associated data from the database to a health care provider.

The method further includes: receiving a patient record including medical test results; determining a predetermined condition in the test results; and updating the shared patient record according to the predetermined condition. The method further includes: accessing the shared patient record; and providing data from the shared patient record to one of a robotic health care device, a patient monitoring device, or a medication compliance monitor.

Further contemplated is a system to perform this method and including computer code conventionally executed at a web server computer to carry out the method and accessed via a client software application running in a conventional web browser at a client computer. The server and client software (programs) may be coded in any convenient computer language.

### BRIEF DESCRIPTION OF THE DRAWINGS

FIG. 1 shows one example of architecture of the system described herein.

FIG. 2 shows flow of a transaction using the FIG. 1 system, involving a patient seeing a physician, obtaining a prescription, and filling it.

FIG. 3 shows interconnections between elements of FIGS. 1 and 2.

### DETAILED DESCRIPTION

One example of an integrated information system described herein may utilize the Internet and its associated well known client-server technologies. The Internet provides a means to create a unique architecture to accomplish a web-based real-time seamless integration between a plurality of stakeholders (actors) involved in the supply, provider and consumer chains of both approved drugs and next generation drugs in clinical development. In some embodiments the integrated systems described herein provide a technology platform that connects any two or more of the patient, the patient's specific genotype, the prescribing physician, the payor, the drug manufacturer, the distributor, the innovator, drug developer and clinical trial manager. In some embodiments the integrated systems described herein provide a technology platform that connects each of the patient, the patient's specific genotype, the prescribing physician, the payor, the drug manufacturer, the distributor, the innovator, drug developer and clinical trial manager. In some embodiments the integrated systems described herein provide real-time information on a case by case basis of the most optimized therapeutic pathways, based on objective analyses of the therapeutic options available to the patient. In some embodiments the integrated systems described herein operate seamlessly and in real-time.

Also, see U.S. Pat. No. 6,012,035 to Freeman, Jr. et al, U.S. Pat. No. 6,845,393 to Murphy et al, and U.S. Pat. No. 7,069,308 to Abrams, all incorporated herein by reference in their entireties. These show various elements and linkages between people and organizations employing communications networks, useful in embodiments of the present system.

In light of the rapid evolution of medicine and the recent findings that there are responders and non-responders to specific therapy depending on a patient's disease, such as a tumor type, as well as depending on the stage of the life-cycle of the disease, such as a tumor, this system provides a “virtual consultant” system (software) to the prescribing physician by linking the patient's specific characteristics, for example the genotype and level of gene expression, to up to date knowledge. In some variations the knowledge pertains to one or more of approved targeted therapeutics as well as next generation technologies in development. By making this information and evidence-based pathway options available in real-time to both patient and physician, the doctor patient relationship may be enhanced, and allow informed clinical decisions and best practices to be more easily implemented.

Furthermore the system may be configured to provide medical alerts to one or more of patient, treating physician, and care-givers on a timely or real time-basis allowing for rapid and timely intervention. In some variations the integrated systems described herein provide medical alerts to each of the patient, treating physician, and care-giver. Such alerts may prevent or minimize the need for hospitalization by averting deterioration in patients struggling with disease. Such alerts include but are not limited to any one or more of changes in biological markers, changes in biochemical and hematological status, changes in radiological status. In some variations the integrated systems described herein are configured to respond to each of changes in biological markers, changes in biochemical and hematological status, changes in radiological status. This system allows not only for rapid and efficient notification of the patient and physician, but also may be configured to indicate treatments based on evidence-based analyses of the best therapeutic options needed to address the patient's health status.

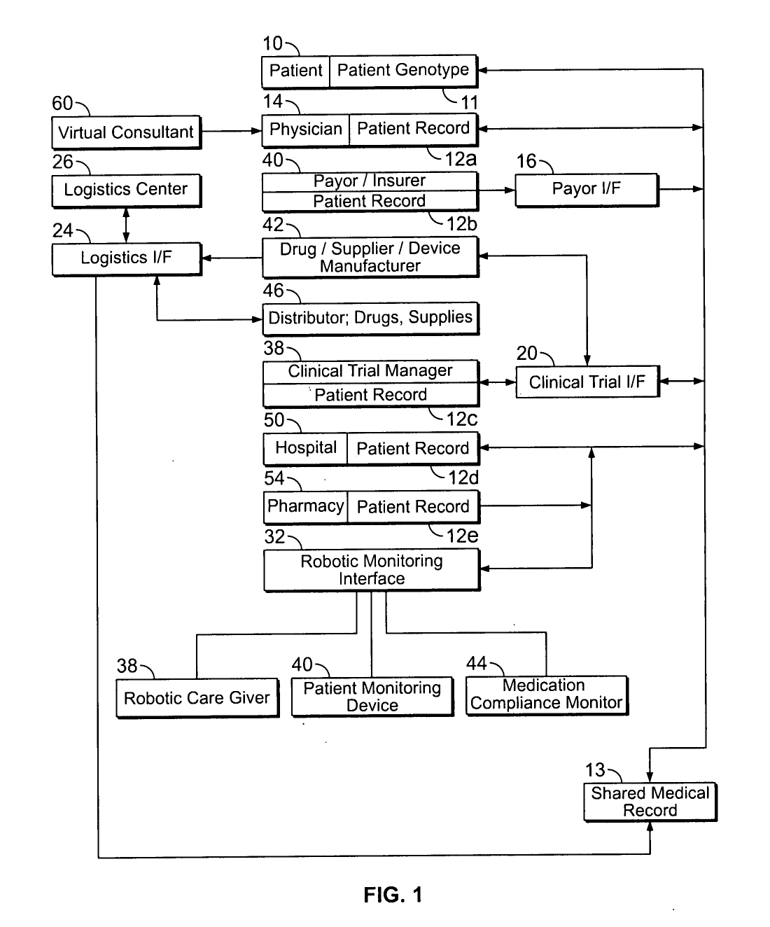

A key element in the system architecture is the integration and interfacing of currently decentralized systems (referring to patients 10 and providers 14, 40, 42, 46, 38, 50, 54) with centralized databases providing one or more of updated evidence based pathway options, payor inputs, clinical trial inputs, inventory management controls and distribution (see FIG. 1).

These interconnected systems include any one or more of:
Patient Medical Records 12a, 12b, 12c, 12d, 12e: These electronic records are maintained by the physician's office 14 or other care provider organizations respectively 40, 42, 46, 38, 50, 54 as a record of the patient's medical history including, for example, the patients molecular profile status, biochemical marker status, clinical and radiological status and genotype 11. In some variations the integrated systems described herein provide one or more of interfaces and alerts relating to therapeutic options or interventions relating to the patients clinical status and all of these together collectively are the shared Patient Medical Record 13.

In one embodiment, the combined clinical analysis together with the biological markers triggers an automatic drop down menu of best practice pathways. In some variations these pathways are generated in a separate, periodically or continuously updated data base (the evidenced-based clinical pathway). In some variations such pathways are generated by any one or more of thought leaders, practicing physicians, third part organizations or guidelines, such as NCCN guidelines, and periodically or continuously updated to interface with the Patient Medical Record via a virtual (computer based) consultant program 60.

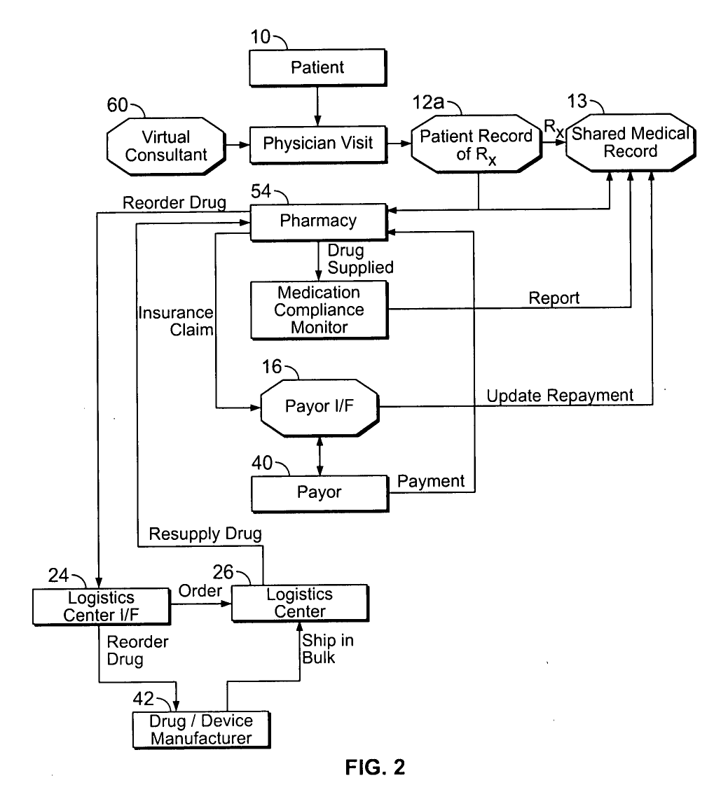

In some variations, with abnormal laboratory results alerts are transmitted to the shared Patient Medical Record 13 informing the patient of the need to take a certain action such as resume a medication, return to the doctor's office for a repeat blood test, etc. In some variations a system of alerts to one or more of patient and physician will occur after or in anticipation of adverse drug interactions or drug to drug interactions. With regard to the care-giver, the Patient Medical Record will allow the physician to establish the record of the treatment protocol and allow the pharmacist and nurse to execute the order. In some variations a bar-coding system ensures that inadvertent incorrect drug administration is minimized. One (non-limiting) version of a process for doing this is shown in FIG. 2 with various elements having the same reference numbers as in FIG. 1.
Patient Medical Record 13: A web-based seamless interface between the various medical Records 12a, . . . , 12e allows patient transparency and portability
Payor or insurer Interface: A seamless interface between other information systems, such as the payor data accumulator and the Patient Medical Record 13 allows, for example, for clarity of patient eligibility criteria, reimbursement status and obligations between provider 14, payor 40 and patient
Clinical Trial Interface 20: In some variations, similar to the evidenced based pathway data base, a separate periodically or continuously updated clinical trial data base is interfaced with the Medical Records 12a, . . . , 12e. In some variations an automatic drop down menu of, for example, ongoing trials which covers the patient's current clinical and molecular status. This clinical trial interface is upgradeable for electronic data capture of patients who elect to enter into such clinical trials and linked to a centralized Clinical Trial Manager Center 38 for centralized data capture
Logistic Center Interface 24: The Medical Record 13 is linked to both a local (e.g., physician's office 14, pharmacist 54 or hospital 50) drug storage system and a centralized logistic distribution center 26. This interface 24 provides mechanism for calculating dose, inventory management at the infusion site, bar coding for inventory management and safety, inventory management at centralized distribution center and supply management from such center.

Connectivity to Remote Robotic Monitoring Systems 32: The Medical Records 12a, 12e and Clinical Trial Interface 38 systems have the capability to interface with a multitude of robotic monitoring and therapeutic (including minimally invasive and surgical procedures) systems currently existing or in development, allowing both remote monitoring of the patient's status as well as remote alerts and prompts for treatment intervention and even for remote management of procedures. Examples of remote technology with which interconnectivity is possible include but are not limited to:
Wireless broadband platforms such as Motiva developed by Philips Electronics.
Remote Robotic Health-care Giver 38 such as the Remote Presence Robot developed by Intouch Health.
Remote Patient Monitoring Devices 40 such as Personal Watcher developed by HomeFree Systems whereby vital signs are monitored via a wearable watch monitor.
Medication Compliance Monitors 44 such as those in development by Tyco International, Eaton Corp (Home Key System) and Accenture (On-line medicine cabinet).

In some embodiments the integrated systems described herein link any one or more of the individual databases, information sources, and parties described herein. In some embodiments the integrated systems described herein link some or all of the individual databases, information sources, and parties described herein.

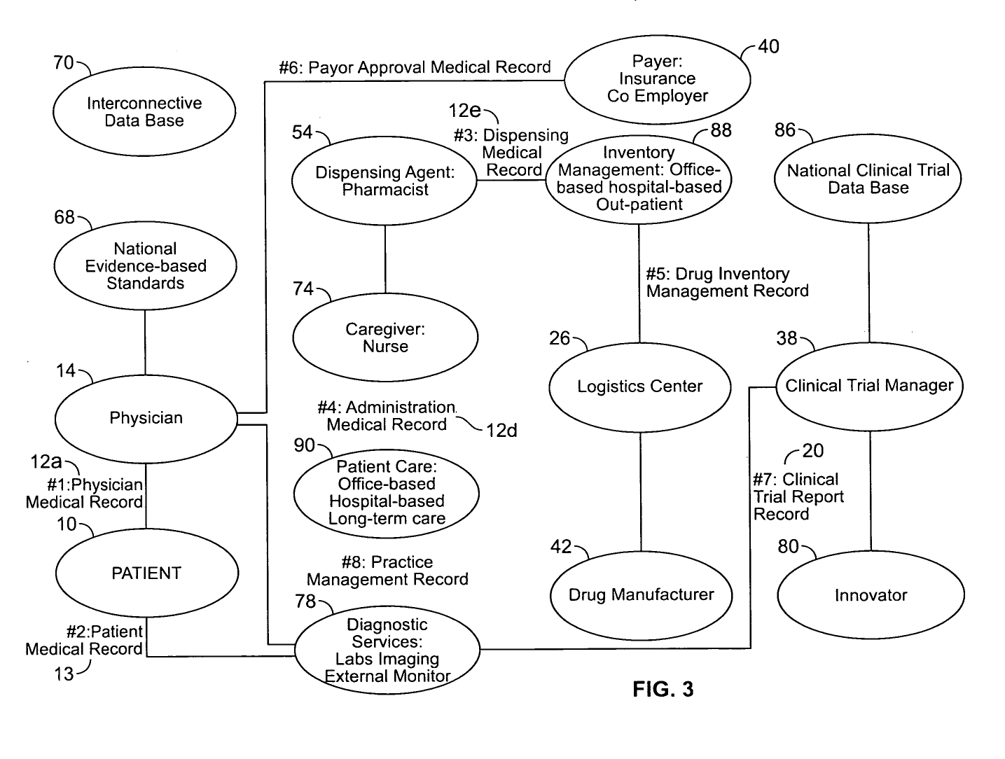

The following properties of each interconnective element of FIGS. 1 and 2 shown further in FIG. 3 are parts of the above describe distributed data base 70 and provide for a holistic, integrated delivery of health care across the entire spectrum of the health care network including the chain involving physician 14, patient 10, patient care facility 50, patient caregiver 74, diagnostic service provider 78, drug dispenser 54, drug distributor 46, drug manufacturer 42, drug innovator 80, clinical trial manager 38, and payor 40. This integrated system will simultaneously and in an integrated fashion address critical issues facing health care today including:
Providing standardized quality of care to the patient, whether the patient is a remote rural setting or in an urban tertiary care environment, based on evidence-based outcomes.
Limiting medication errors which account for thousands of adverse events and death annually.
Maintaining patient privacy.
Providing timely and preventative interventions avoiding complications requiring costly and life-threatening hospitalization.
Providing state of the art customized care based on patient's diagnostic genotype and pathological biomarkers and state of the art clinical medicine and clinical trials.
Saving health care costs by providing efficient delivery of health care throughout the continuum including treatment, drug costs and efficient payor approval process.

Patient Medical Record #1 of FIG. 3 is the final and validated Medical Record 13. Any entries between other “shadow” records (records 2 to 8 of FIG. 3) require conventional validation processes and tools prior to acceptance in the Medical Record 13. This Record 13 will be portable and establish HIPPA compliant methods to maintain patient privacy. This Record will provide efficient time-saving and knowledge gathering tools to allow the physician to provide evidence-based care with national quality standards by allowing the physician real-time access to the following information and data:
Patient's full prior history including all diagnostic tests and pathological findings.
Patient's current clinical, diagnostic lab and imaging studies.
Based on the patient's current clinical, genotype and pathological status, immediate real-time access to current standards of care with regard to diagnostic testing and therapeutic interventions. Such access is provided by the National evidence-based standards data base 68 which may interconnect with the patient's profile via the depicted interconnective data base.
Real-time access to the patient's diagnostic services data including access to real-time remote monitoring devices.
Interconnectivity with the patient shadow charts in which the patient may enter data, symptoms etc. and physician will have sole authority to add to the Patient's Medical Record information from the patient's shadow chart.
Physician alerts regarding abnormal diagnostic data (tied to interactive alerts and intervention recommendations from the National standards data base 68).
Interactivity with the Payor Medical Record #6 and Practice Management Record #8 generated as a result of patient care 90 to ensure payor coverage for therapeutic and diagnostic intervention and reducing the need for manual confirmation of benefits.

Patient Medical Record (#2 of FIG. 3). The feature of this Record 13 is the ability to establish a “shadow” record based on the initial inputs from the Patient Medical Record #1 and all the validated inputs from Records 1 to 8 of FIG. 3. This Record is comprehensive and allows the patient to transport his or her life-time information from care-giver to care-giver. The treating care-giver is able to receive inputs from the patient but will only add it to the final Medical Record 13 upon validation or approval by the physician or other care-giver.

The Record 13 provides the patient the following benefits:
Access to state of the art treatment pathways based on evidence-based outcomes.
Access to diagnostic information in real-time allowing preventative interventions.
Access to medication bar code information, avoiding medication errors. Compliance tools to remind the patient of the need of therapeutic, diagnostic intervention including compliance with treatment plan.
Access to knowledge of insurance status.

The remaining Records #3 to #8 in FIG. 3 have similar or related content and functionality according to the indicated use and associated medical provider entity (as shown in FIG. 3) involved with that particular record.

Further, in the development of next generation therapeutics (drugs, devices, treatments) as well as the delivery of current medical care, huge inefficiencies exist, adding to the cost of health care and reducing the quality of such care by medication errors, delays in innovative drug development and delays and inefficiency of information transfer between patient, physician, healthcare giver, diagnostic services, clinical trial operations and drug distributor and manufacturer. To date, seamless and integrated web-based systems linking each of these entities and providing significantly increased efficiencies have not been developed and are sorely needed. The interactive web-based system described in this application provides methods to directly address issues described below, but is not so limited. For example:
Doctor-Patient Communication: Through the direct interconnectivity between the various Medical Records 12a, . . . , 12e, mundane and inefficient administrative patient care tasks such as appointment scheduling or rescheduling can occur through web-based communication. This communication includes question-answer interaction relating to the patient's status and progress. Since the entire body of patient data is available to the physician or other caregiver instantaneously, the physician has more time to spend with the patient instead of managing administrative tasks. Each medical record is structured such that the entire record (rather than just individual pages) can be accessed or printed by a computer with a single key stroke, for maximal portability. This has some similarities to the known Vista system, implemented currently in the VA (Veteran's Administration) health care system.
Clinical-Investigator-clinical trial monitor communication (e.g., for drug and device and treatment trials): The current method of validating a clinical trial case report with the actual patient chart is highly inefficient and usually requires the physical travel of the clinical trial monitor to the clinical sites. Instead, with the current system this monitoring can be done from any location using the national clinical trial database 86.
Drug Dispensing-administration interaction: By bar coding the medication (or its container) and associating the bar code with the Medical Records as well as with the insurer reimbursement system and the drug inventory management system 88, there are multiple points of validation so as to prevent the patient from receiving an incorrect medication. If such an event happens, upon detection by the present system an alert is provided to warn the healthcare giver. Such an alert is triggered by a bar code patient identifier on, e.g. the patient's ID bracelet, for both in or out patients. The interconnectivity of these bar codes from drug manufacturer, distributor, payor, physician, patient and pharmacist and further being tied to robotic dispensing systems is highly advantageous.

This disclosure is illustrative but not limiting; further modifications will be apparent to those skilled in the art in light of this disclosure, and are intended to fall within the scope of the appended claims.

What is claimed as new and desired to be protected by Letters Patent of the United States is:

1. A computer enabled method for exchange of patient related medical data, comprising the acts of:
providing a patient record having data pertaining to a patient, the record being held by a first health care organization;
communicating over a computer network at least a portion of the record to a second health care organization, thereby establishing a shared patient record; and
allowing access to the shared patient record over the computer network by a third health care organization.

2. The method of claim 1, wherein the computer network is the Internet and the access is via a web browser.

3. The method of claim 1, wherein each of the organizations is one of a physician's office, hospital, pharmacy, insurer, payor for medical care, drug manufacturer, drug distributor, drug developer, clinical trial manager, laboratory, or test facility.

4. The method of claim 1, wherein the data includes at least one of the patient's genotype, gene-over-expression, or specific drug response.

5. The method of claim 1, further comprising the acts of:
establishing a database relating to a clinical trial of a drug, medical device, or procedure; and
storing at least a part of the shared patient record in the database.

6. The method of claim 5, further comprising accessing the database to show a particular patient's medical status and clinical trial status.

7. The method of claim 1, further comprising:
providing a distribution function; and
accessing the shared patient record by the distribution function;
wherein the distribution function determines distribution of drugs, medical devices, or medical supplies to the patient.

8. The method of claim 7, wherein the distribution function performs activities selected from the group consisting of calculating drug doses, managing local drug inventories, and managing central location drug inventories.

9. The method of claim 1, further comprising the acts of:
providing a database of general clinical data;
associating data from a patient record with the database; and
providing the associated data from the database to a health care provider.

10. The method of claim 1, further comprising the acts of:
receiving a patient record including medical test results;
determining a predetermined condition in the test results; and
updating the shared patient record according to the predetermined condition.

11. The method of claim 1, further comprising the acts of:
accessing the shared patient record; and
providing data from the shared patient record to one of a robotic health care device, a patient monitoring device, or a medication compliance monitor.

12. The method of claim 1, further comprising the acts of:
identifying a medication with a particular patient record;
comparing the identified medication to the patient record; and
providing an alert if a medication does not match the patient record.

13. A system to perform the method of claim 1, comprising computer code executed at a server computer, and accessed via a web browser at a client computer.

14. A computer enabled system for exchange of patient medical data, comprising:
storage for a patient record having data pertaining to the patient, the record being maintained by a first health care organization;
a port for access over a computer network to at least a portion of the record to a second health care organization thereby establishing a shared patient record; and
a port for access to the shared patient record by a third health care organization.
